(19) United States
(12) Patent Application Publication
(10) Pub. No.: US 2024/0225786 A1
(43) Pub. Date: Jul. 11, 2024

(54) RETAINER AND METHOD FOR MANUFACTURING SAME

(71) Applicant: SMILECAD CO., LTD, Busan (KR)

(72) Inventors: Seok Joon KIM, Busan (KR); Jae Ho JEON, Busan (KR)

(73) Assignee: SMILECAD CO., LTD, Busan (KR)

(21) Appl. No.: 18/559,338

(22) PCT Filed: Jul. 29, 2022
(86) PCT No.: PCT/KR2022/011157

§ 371 Date: Nov. 6, 2023

(30) Foreign Application Priority Data
Aug. 5, 2021 (KR) 10-2021-0103444

(51) Int. Cl. A61C 7/08; B23K 26/38; A61C 7/10

(52) U.S. Cl. CPC A61C 7/08; B23K 26/38; A61C 7/10; A61C 2201/007

(57) ABSTRACT

Proposed is a retainer and a method for manufacturing the retainer. The retainer has a body which is in close contact with a tooth arrangement and which is formed of a shape memory alloy material. The body is manufactured by being laser cut from a base material of the shape memory alloy material on the basis of 3D scanning data of the tooth arrangement and then a width thereof is modified. The method includes a process of acquiring three-dimensional data of the tooth arrangement, a data processing process of generating processing line data on the basis of the scanning data, a laser cutting process of manufacturing a body forming part by laser cutting the shape memory alloy material, and a width modification process of thermally treating the body forming part after expanding or reducing and fixing the body forming part so that the width thereof is widened or narrowed.

### TECHNICAL FIELD

The present disclosure relates to a retainer and a method for manufacturing the retainer. More particularly, the present disclosure relates to a retainer formed of a shape memory alloy material and a method for manufacturing the retainer.

### BACKGROUND ART

A retainer is a type of a tooth arrangement maintenance device used to maintain a tooth arrangement after removing an orthodontic device after orthodontic treatment is finished.

Such a retainer may be largely divided into an adhesive retainer that is attached to the teeth and a removable retainer that is capable of being arbitrarily detached from the teeth like a mouthpiece.

Generally, the adhesive retainer is manufactured by a person bending a wire formed of a stainless steel material corresponding to a plaster model shape of the teeth that have been treated.

In addition, in the removable retainer, a retainer body that is in close contact with front side surface of all teeth is manufactured by a person bending a wire formed of a stainless steel material corresponding to a plaster model shape of the teeth that have been treated, and the retainer body is manufactured such that the retainer body is in close contact with the palate by turning around rear surface of the rearmost teeth. In addition, when the retainer body is manufactured, an acrylic resin portion that covers the palate is required to be formed. After the retainer body is fixed to the plaster model shape, the acrylic resin portion is manufactured by alternately spraying a powder polymer and a liquid monomer on a palate portion so that the polymer and the monomer are mixed.

Since the conventional retainer manufactured by bending a stainless steel material can be deformed, there is an advantage that the manufacturing process of the retainer is easily performed, and there is an advantage that the retainer allows minute physiological movements of the teeth when the teeth receive a force since the retainer has a certain amount of elasticity. However, since the retainer is not in completely close contact with each tooth surface, the retainer crosses a concave portion of each of interdental spaces of inner surfaces of teeth, so that there is are problems that tongue discomfort occurs, food is caught in or plaque is formed in the associated concave portion, and gum inflammation and tooth decay occur.

In addition, since the conventional wire is capable of being deformed, there is a problem that a tooth arrangement may be disarranged, and there is a problem that the tooth arrangement may be deformed when broken or bent portions of the wire are unfolded or twisted three strands of the wire are untwisted.

Recently, a retainer to which a shape memory alloy is applied has been developed to prevent the deformation of the retainer to which a stainless steel material is applied and to improve the correction effect.

In this regard, in Korean Patent Application Publication No. 10-2014-0115520 which is a related document, a tooth retainer apparatus to which a wire formed of a shape memory alloy is applied is disclosed.

However, the tooth retainer apparatus in the related document still has a problem that the apparatus cannot make perfect contact with outer surfaces of the teeth, and is manufactured by coupling a plurality of brackets and wires to each other, so it is difficult to manufacture the tooth retainer apparatus.

### DISCLOSURE

### Technical Problem

Accordingly, the present disclosure has been made keeping in mind the above problems occurring in the related art, and an objective of the present disclosure is to provide a retainer and a method for manufacturing the retainer in which a retainer body is in close contact with a plurality of the teeth that form a tooth arrangement.

In addition, another objective of the present disclosure is to provide a retainer and a method for manufacturing the retainer in which a retainer body is formed of a shape memory alloy material and formed as a single integrated configuration.

In addition, still another objective of the present disclosure is to provide a retainer and a method for manufacturing the retainer capable of preventing breakage of a retainer body.

### Technical Solution

In order to achieve the above objectives, according to the present disclosure, there is provided a retainer including: a body formed of a shape memory alloy material and formed as a single integrated configuration, the body having a first surface in close contact with each tooth along a tooth arrangement, wherein the body includes: a curved protrusion part that protrudes toward an interdental space so that the curved protrusion part is inserted into the interdental space, the curved protrusion part being in close contact with inner tooth surfaces of a plurality of teeth forming the interdental space; and a plurality of support parts in close contact with tooth surfaces of each tooth outside the interdental space, and the body is manufactured by being laser cut from a base material of the shape memory alloy material on the basis of 3D scanning data of the tooth arrangement and then a width between distal ends thereof being modified so as to correct at least a shape error caused by the laser cutting.

In addition, in order to correct the shape error, the body may be laser cut from the base material, then may expand and may be fixed such that the width between the distal ends thereof is widened or may be reduced and fixed such that the width between the distal ends thereof is narrowed, and then may be thermally treated, thereby manufacturing the body in which the modified width between the distal ends is maintained.

In order to achieve the above objectives, according to the present disclosure, there is provided a method for manufacturing a retainer provided with a body which includes a curved protrusion part that protrudes so as to be inserted into an interdental space so that the body is in close contact with tooth surfaces of a plurality of teeth forming a tooth arrangement and which includes a support part that is in close contact with tooth surfaces of each tooth outside the interdental space, the method including: a three-dimensional scanning data acquisition process in which three-dimensional scanning data of the tooth arrangement are acquired by using a three-dimensional scanning apparatus; a data processing process in which processing line data defining a laser cutting shape for manufacturing the body are generated on the basis of the scanning data of the tooth arrangement; a laser cutting process in which a body forming part configuring the body is manufactured by laser cutting a base material formed of a shape memory alloy material on the basis of the generated processing line data; and a width modification process in which the body forming part expands and is fixed such that a width between distal ends thereof is widened or is reduced and fixed such that the width between the distal ends thereof is narrowed, and then is thermally treated, thereby manufacturing the body in which the modified width between the distal ends is maintained.

In addition, in the laser cutting process, a portion cut from the base material may be removed, and cutting spaces may be formed on opposite sides with respect to the body forming part, and the width modification process may include: a fixing process in which a first side surface of the body forming part and an inner facing surface of the base material facing each other through a first side cutting space are brought into close contact with each other so as to remove the first side cutting space in the cutting spaces of the opposite sides, thereby fixing the body forming part to the base material while the body forming part is in a state in which the width between the distal ends thereof is modified; and a thermal treatment process in which the body forming part having the modified width between the distal ends and fixed to the base material is thermally treated so that a shape of the body forming part having the modified width between the distal ends is maintained.

In addition, the method may further include an additional processing process which is performed after the laser cutting process and in which the body forming part is cut so that changes in vertical curve of tooth surfaces of each tooth and in vertical width of the interdental space are reflected to the body forming part.

### Advantageous Effects

In the retainer and the method for manufacturing the retainer according to an embodiment of the present disclosure, following effects may be realized.

The retainer according to an embodiment of the present disclosure includes the body which is formed of the shape memory alloy material and which is formed as a single integrated configuration, the body having the first surface in close contact with each tooth along the tooth arrangement. At this time, the body is manufactured by being laser cut from the base material of the shape memory alloy material on the basis of the 3D scanning data of the tooth arrangement and then the width between distal ends thereof being modified so as to correct at least the shape error caused by the laser cutting.

Specifically, as the portion cut by laser is removed from the base material during the laser cutting, the error occurs between the shape of the manufactured body and the shape of the required body. When such a shape error occurs, it is difficult for the body to be stably in close contact with the tooth arrangement, and there is a problem that a foreign body sensation increases and a failure rate increases.

In order to correct the shape error, as the body is laser cut and then the width is modified and manufactured, the body is stably in close contact with the tooth arrangement, so that the tooth arrangement correction effect may be maximized and the occurrence of foreign body sensation may be prevented.

In the method for manufacturing the retainer according to an embodiment of the present disclosure, following effects may be realized.

First, the method for manufacturing the retainer according to an embodiment of the present disclosure includes the three-dimensional scanning data acquisition process in which the three-dimensional scanning data of the tooth arrangement are acquired by using the three-dimensional scanning apparatus, the data processing process in which the processing line data defining the laser cutting shape for manufacturing the body are generated on the basis of the scanning data of the tooth arrangement, the laser cutting process in which the body forming part configuring the body is manufactured by laser cutting the base material formed of the shape memory alloy material on the basis of the generated processing line data.

According to method for manufacturing the retainer as described above, the manufacturing cost of the retainer may be reduced since the body is formed as the single integrated configuration.

In addition, as the body is manufactured by being laser cut on the basis of the three-dimensional scanning data, the period required for manufacturing the retainer may be significantly reduced.

In addition, as the time required for manufacturing the retainer is reduced, the deformation of the tooth arrangement during the manufacturing period of the retainer is minimized, so that the manufactured retainer and the teeth may be stably matched, and the satisfaction of the patient may be significantly increased.

Second, the method for manufacturing the retainer according to an embodiment of the present disclosure includes the width modification process in which the body forming part expands and is fixed such that the width between distal ends thereof is widened or is reduced and fixed such that the width between the distal ends thereof is narrowed, and then is thermally treated, thereby manufacturing the body in which the modified width between distal ends is maintained.

According to the method for manufacturing the retainer as described above, the body in which the shape error generated by the laser cutting is removed may be manufactured. Furthermore, since the body is more stably in close contact with the tooth arrangement, the tooth arrangement correction effect may be maximized and the occurrence of foreign body sensation may be prevented.

In addition, by the width modification process, the retainer for expansion treatment or reduction treatment of the tooth arrangement may be effectively manufactured.

Specifically, in order to expand or reduce the tooth arrangement, the body having the width corresponding to the final correction state of the tooth arrangement is required. After the body forming part is manufactured by laser cutting the body forming part on the basis of the 3D scanning data of the tooth arrangement before the orthodontic treatment is performed, the body forming part is manufactured such that the width of the body forming part is modified to the required width through the width modification process, so that the body required for the expansion correction treatment or the reduction correction treatment of the tooth arrangement may be manufactured.

Third, in the laser cutting process, the portion cut from the base material is removed, and the cutting spaces are formed on the opposite sides with respect to the body forming part. Furthermore, the width modification process includes the fixing process in which the first side surface of the body forming part and the inner facing surface of the base material facing each other through the first side cutting space are brought into close contact with each other so as to remove the first side cutting space in the cutting spaces of the opposite sides, thereby fixing the body forming part to the base material while the body forming part is in the state in which the width between the distal ends thereof is modified, and the width modification process includes the thermal treatment process in which the body forming part having the modified width between the distal ends and fixed to the base material is thermally treated so that the shape of the body forming part having the modified width between the distal ends is maintained.

In the fixing process, since the first side surface of the body forming part is in close contact with the inner facing surface of the base material, the width of the body forming part may be set such that the shape error due to the formation of the cutting spaces is capable of being corrected. Therefore, width adjustment of the body forming part for correcting the shape error may be easily performed by using the base material, and the manufacturing time may be reduced.

### DESCRIPTION OF DRAWINGS

FIG. 1 is a view illustrating a state in which a retainer according to an embodiment of the present disclosure is attached to the teeth.

FIG. 2 is a plan view illustrating the retainer according to an embodiment of the present disclosure.

FIG. 3 shows cross-sections of a first portion and a second portion of a body according to an embodiment of the present disclosure, the body being attached to the teeth.

FIG. 4 is a plan view illustrating a curved protrusion part according to an embodiment of the present disclosure.

FIG. 5 is a front view illustrating the curved protrusion part according to an embodiment of the present disclosure.

FIG. 6 is a flowchart illustrating a manufacturing method of a retainer according to an embodiment of the present disclosure.

FIG. 7 is a flowchart specifically illustrating an additional processing process according to an embodiment of the present disclosure.

FIG. 8 is a flowchart specifically illustrating a width modification process according to an embodiment of the present disclosure.

FIG. 9 is a view schematically illustrating a manufacturing process of the body according to an embodiment of the present disclosure.

FIG. 10 and FIG. 11 are views illustrating a processing operation performed in a data processing process according to an embodiment of the present disclosure.

FIG. 12 is a view illustrating a shape of a base material after a laser cutting process is performed according to an embodiment of the present disclosure.

FIG. 13 is a view illustrating a state in which a width of a body forming part is modified to a shape required for the base material in a fixing process according to an embodiment of the present disclosure.

FIG. 14 is a view illustrating the retainer having an expanded width manufactured for expanding and correcting the tooth arrangement according to another embodiment of the present disclosure.

FIG. 15 is a view illustrating the retainer having a reduced width manufactured for reducing and correcting the tooth arrangement according to still another embodiment of the present disclosure.

### MODE FOR INVENTION

Hereinafter, an embodiment of the present disclosure will be described in detail with reference to the accompanying drawings.

However, the spirit of the present disclosure is not limited to the presented embodiment, and by addition, modification, and removal of another component, other embodiments included within other degenerative inventions or the scope of the spirit of the present disclosure may be easily proposed.

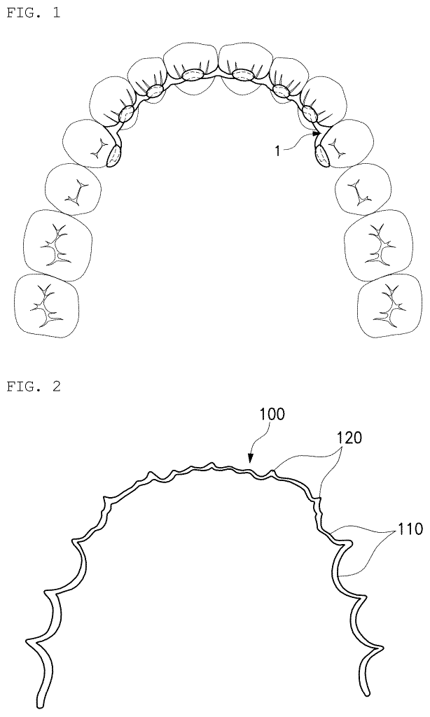

FIG. 1 is a view illustrating a state in which a retainer according to an embodiment of the present disclosure is attached to teeth.

FIG. 2 is a plan view illustrating the retainer according to an embodiment of the present disclosure.

FIG. 3 shows cross-sections of a first portion and a second portion of a body according to an embodiment of the present disclosure, the body being attached to the teeth.

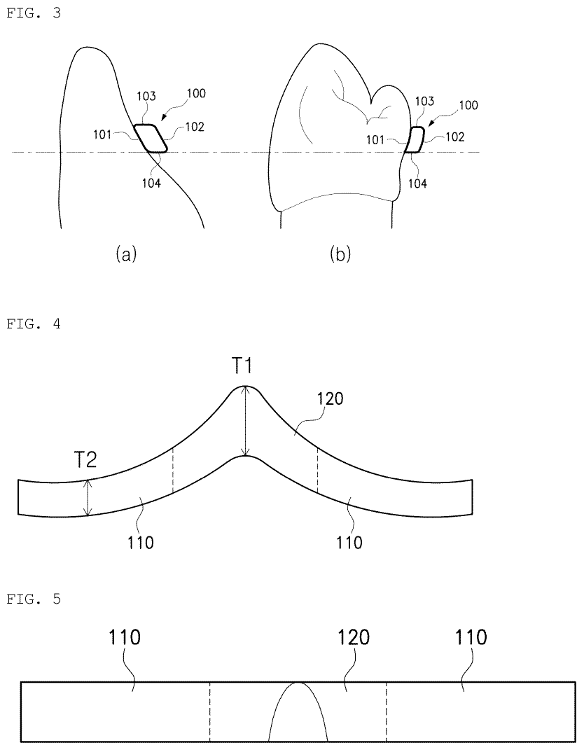

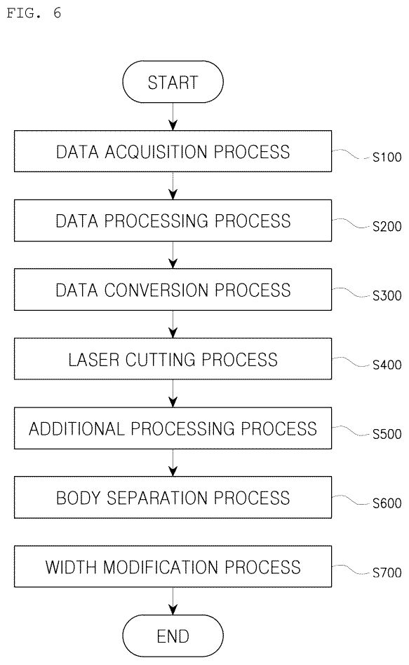

FIG. 4 is a plan view illustrating a curved protrusion part according to an embodiment of the present disclosure.

FIG. 5 is a front view illustrating the curved protrusion part according to an embodiment of the present disclosure.

A retainer 1 and a method for manufacturing the retainer 1 of the present disclosure may be applied to a removable retainer, or may be applied to an adhesive retainer.

The retainer 1 according to an embodiment of the present disclosure may include a body 100 having a bow shape curved corresponding to a tooth arrangement of a person.

When the body 100 is formed such that the body 100 is in contact with the teeth from a front side of the tooth arrangement, and a resin region covering the palate is coupled to and applied to the body 100, the removable retainer detachably coupled to the tooth arrangement may be realized.

On the other hand, when the body 100 is applied such that the body 100 is in contact with the teeth from the front side or a rear side of the tooth arrangement and is attached by an adhesive material, the adhesive retainer may be realized.

Hereinafter, the adhesive retainer which is in contact with a back surface of the teeth from the rear side of the tooth arrangement and which is attached by an adhesive material will be described as an example of the retainer 1, and will be described in detail.

The body 100 may be formed such that the body 100 is in close contact with each tooth and is attached to each tooth with a separate adhesive material by closely adhering to each tooth along the tooth arrangement formed by a plurality of teeth.

In addition, the body 100 may be formed of a shape memory alloy material.

Therefore, the tooth arrangement may be stably maintained by the body 100. Furthermore, even when the tooth arrangement is disarranged while the body 100 is attached to each of the teeth, the tooth arrangement may be restored to an initial even tooth arrangement state by a shape restoration force of the body 100.

More specifically, the body 100 may be formed long such that the body 100 generally corresponds to the tooth arrangement, and may be formed such that the body 100 has an approximate bow shape when viewed from above. In addition, the body 100 may be formed such that the body 100 has a predetermined vertical height and a predetermined front-to-rear thickness.

The body 100 may be formed such that the body 100 has a front surface 101 that is attached to a tooth surface, a rear surface 102 that is positioned opposite to the front surface 101, an upper surface 103 that connects an upper end of the front surface 101 and an upper end of the rear surface 102 to each other, and a lower surface 104 that connects a lower end of the front surface 101 and a lower end of the rear surface 102 to each other.

Referring to FIG. 1 and FIG. 2, the body 100 may include at least one support part 110 attached to a tooth surface of each tooth, and may include at least one curved protrusion part portion 120 inserted into an interdental space formed between teeth adjacent to each other.

The curved protrusion part 120 may be defined as a part of the body 100 which protrudes toward the interdental space such that the curved protrusion part 120 is inserted into the interdental space and is in close contact with side surfaces of the teeth.

When a plurality of curved protrusion parts 120 is formed, the plurality of curved protrusion parts 120 may be considered to be connected to each other by the support part 110.

Meanwhile, the body 100 may be formed by reflecting a shape of a tooth surface of each tooth and a shape of the interdental space such that a contact area of the body 100 with each tooth may increase.

For example, the body 100 may be formed by reflecting a shape of the interdental space of the tooth arrangement, a tooth surface curve of each tooth, a tooth surface inclination of each tooth, and so on. At this time, the tooth surface curve may include a horizontal direction tooth surface curve and a vertical direction tooth surface curve. In addition, the tooth surface inclination may include a horizontal direction tooth surface inclination and a vertical direction tooth surface inclination.

Therefore, since the contact area between the body 100 and the teeth is increased, more stable adhesion of the body 100 is capable of being realized, so that the body 100 is capable of stably supporting the teeth. In addition, foreign substances may be prevented from being caught in gaps between the body 100 and the teeth.

More specifically, referring to FIG. 3, each tooth constituting the tooth arrangement may have various tooth surface shapes, and may have a tooth surface shape which is curved, inclined, or vertical.

The front surface 101 of the body 110 may be formed such that the front surface 101 is curved, inclined, or vertical corresponding to the tooth surface shape of each tooth. That is, the support part 110 and the curved protrusion part 120 may be formed such that front surfaces of the support part 110 and the curved protrusion part 120 are curved, inclined, or vertical.

At this time, when a plurality of support parts 110 and a plurality of curved protrusion parts 120 are formed, each front surface of the support parts 110 and the curved protrusion parts 120 may have a different cross-sectional shape. That is, each front surface of the plurality of support parts 110 and the plurality of curved protrusion parts 120 may have an independent cross-sectional shape.

Of course, one tooth may have a tooth surface shape that is capable of being variously formed according to a position of the tooth. Accordingly, even the front surface of each of one support part 110 and one curved protrusion part 120 may not have a uniform cross-sectional shape but may have an independent cross-sectional shape along an extension direction thereof. That is, each part of the body 100 may be continuous and may have an independent cross-sectional shape along the extension direction.

Meanwhile, the rear surface 102 of the body 100 may be formed in a shape corresponding to the shape of the front surface 101, and may be formed parallel to the front surface 101.

Meanwhile, the upper surface 103 and the lower surface 104 of the body 100 may also be formed in the same shapes, and may be formed parallel to each other. As an example, the upper surface 103 and the lower surface 104 of the body 100 may be formed in generally horizontal planar shapes.

Therefore, the body 100 may be formed such that the body 100 has a generally identical vertical height.

Meanwhile, cutting, polishing, and so on may be performed on corner parts of the body 100 such that the corner parts of the body 100 have rounded shapes.

Referring to FIG. 3, the cross-sectional shapes of the support parts 110 of the body 100 in contact with the teeth are described as an example. When a tooth surface of a first tooth in contact with the body 100 is downwardly inclined from a front side to a rear side as illustrated in FIG. 3(a), a corresponding front surface of a first portion of the body 100 may be formed such that the front surface of the first portion of the body 100 is downwardly inclined from the front side to the rear side.

In addition, a rear surface of the first portion of the body 100 may also be formed such that the rear surface of the first portion of the body 100 is downwardly inclined from the front side to the rear side. In addition, an upper surface and a lower surface of the first portion of the body 100 may be formed such that the upper surface and the lower surface of the first portion of the body 100 are horizontal to each other.

On the other hand, when a tooth surface of a second tooth in contact with the body 100 is upwardly inclined from the front side to the rear side as illustrated in FIG. 3(b), a corresponding front surface of a second portion of the body 100 may be formed such that the front surface of the second portion of the body 100 is upwardly inclined from the front side to the rear side.

In addition, a rear surface of the second portion of the body 100 may also be formed such that the rear surface of the second portion of the body 100 is upwardly inclined from the front side to the rear side. In addition, an upper surface and a lower surface of the second portion of the body 100 may be formed such that the upper surface and the lower surface of the second portion of the body 100 are horizontal to each other.

Meanwhile, the curved protrusion part 120 may be formed in a shape that generally continues smoothly so that there are no sharp edges and valleys when the curved protrusion part 120 is viewed from above.

As an example, the curved protrusion part 120 may be formed such that an end portion that protrudes from the front surface of the curved protrusion part 120 is rounded. In addition, the curved protrusion part 120 may be formed such that an end portion recessed from the rear surface of the curved protrusion part 120 is rounded.

Therefore, occurrence of a fracture of the curved protrusion part 120 that has a curved shape may be effectively prevented.

In addition, as illustrated in FIG. 4, the curved protrusion part 120 may be formed such that the curved protrusion part 120 have a front-to-rear thickness thicker than a front-to-rear thickness of the support part 110.

That is, a front-to-rear thickness T1 of the protruding end portion of the curved protrusion part 120 may be thicker than a front-to-rear thickness T2 of the support part 110. In addition, the curved protrusion part 120 may be formed such that a front-to-rear thicknesses of the curved protrusion part 120 is gradually decreased so as to correspond to the front-to-rear thickness T2 of the support part 110 as the curved protrusion part 120 approaches the support part 110.

At this time, the curved protrusion part 120 may be formed such that the front-to-rear thickness T1 of the protruding end portion of the curved protrusion part 120 is 10% to 30% thicker than the front-to-rear thickness T2 of the support part 110. Preferably, the curved protrusion part 120 may be formed such that the front-to-rear thickness T1 of the protruding end portion of the curved protrusion part 120 is 20% thicker than the front-to-rear thickness T2 of the support part 110.

For example, the body 100 may be formed in various thicknesses according to specifications. For example, the body 100 may be provided such that the body 100 has a thickness of a 0.3 mm specification, a 0.43 mm specification, a 0.5 mm specification, and so on.

When the body 100 has the thickness of the 0.3 mm specification, the support part 110 may be formed such that the front-to-rear thickness T2 of the support part 110 is 0.3 mm. In addition, the curved protrusion part 120 may be formed such that the front-to-rear thickness T1 of the protruding end portion of the curved protrusion part 120 is 0.36 mm.

Therefore, due to thickness reinforcement of the curved protrusion part 120, occurrence of fracture of the curved protrusion part 120 may be more effectively prevented, and deformation of the body 100 may be effectively prevented.

In addition, as illustrated in FIG. 5, the curved protrusion part 120 may be formed such that a width of the curved protrusion part 120 is changed gradually toward an upper side of the curved protrusion part 120 from a lower side of the curved protrusion part 120 by corresponding to a shape of an interdental space.

For example, the body 100 may be attached to a maxillary tooth arrangement, or may be attached to a mandibular tooth arrangement. An interdental space formed in the maxillary tooth arrangement has a characteristic that a width of the interdental space increases toward an upper side of the interdental space from a lower side of the interdental space. In addition, an interdental space formed in the mandibular tooth arrangement has a characteristic that a width of the interdental space decreases toward an upper side of the interdental space from a lower side of the interdental space.

When the body 100 is attached to the mandibular tooth arrangement, the curved protrusion part 120 may be formed such that the width of the curved protrusion part 120 gradually decreases toward the upper side of the curved protrusion part 120 from the lower side of the curved protrusion part 120. That is, the front surface of the curved protrusion part 120 may be regarded as a structure formed by reflecting the inclinations, the curves, and so on of the inner surfaces of the teeth forming the interdental space.

Therefore, the curved protrusion part 120 is capable of being inserted into the interdental space without interruption, and may be tightly in close contact with the inner side surfaces of the teeth forming the interdental space.

Meanwhile, the body 100 may be manufactured by performing additional processing for shape modifying of a shape memory alloy material after laser cutting the shape memory alloy material.

In addition, the body 100 may be manufactured by performing a thermal treatment after performing the laser cutting to the shape memory alloy material. Therefore, the body 100 may have higher hardness, and a shape of the body 100 may be stabilized.

In addition, the body 100 may be manufactured by polishing a surface of the body 100. Therefore, the body 100 may be formed such that the body 100 has a smoother surface, and a sharp portion of the body 100 may be removed, so that the body 100 may be formed in a generally safe structure.

Hereinafter, a manufacturing method of the retainer 1 according to an embodiment of the present disclosure will be described in detail with reference to the drawings.

FIG. 6 is a flowchart illustrating a manufacturing method of a retainer according to an embodiment of the present disclosure.

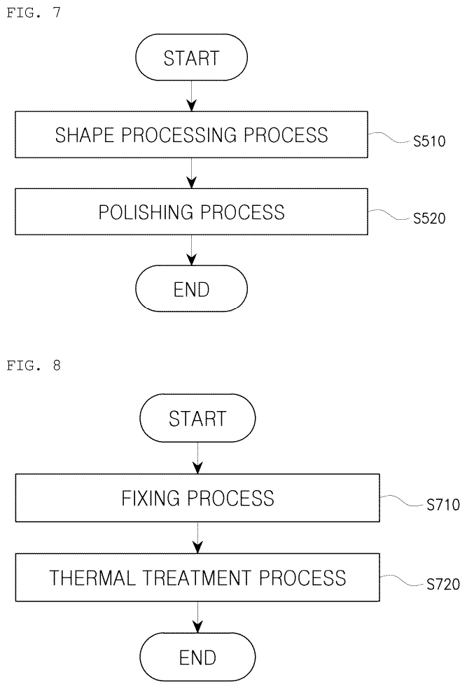

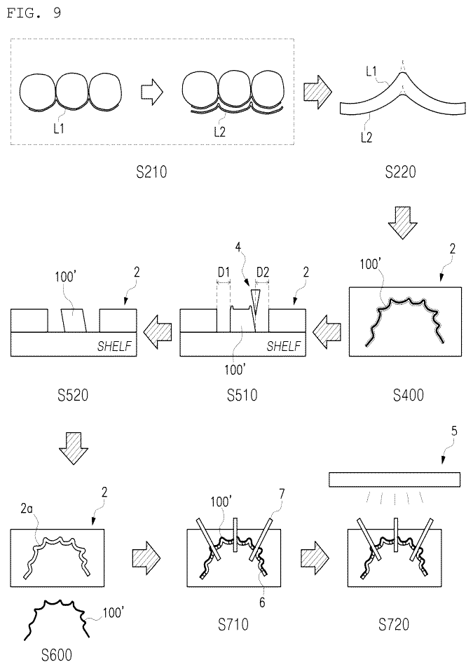

FIG. 7 is a flowchart specifically illustrating an additional processing process according to an embodiment of the present disclosure.

FIG. 8 is a flowchart specifically illustrating a width modification process according to an embodiment of the present disclosure.

FIG. 9 is a view schematically illustrating a manufacturing process of the body according to an embodiment of the present disclosure.

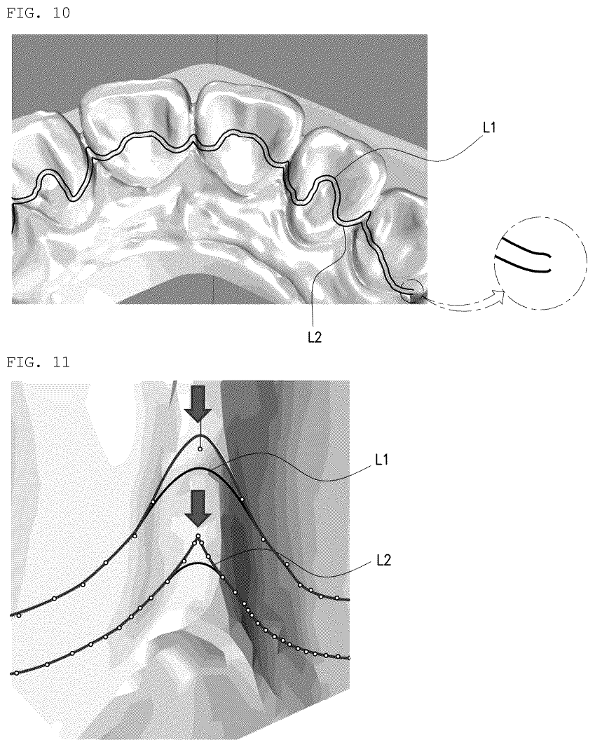

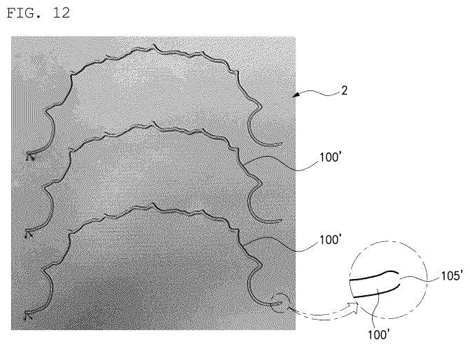

FIG. 10 and FIG. 11 are views illustrating a processing operation performed in a data processing process according to an embodiment of the present disclosure.

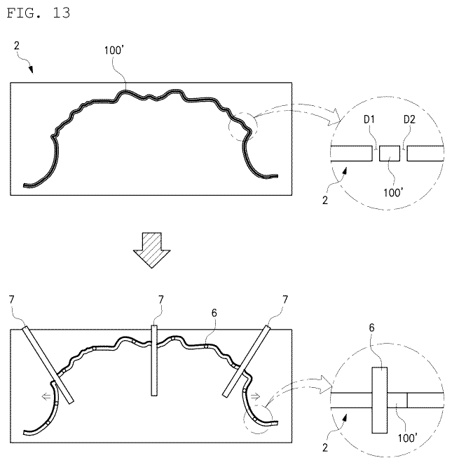

FIG. 12 is a view illustrating a shape of a base material after a laser cutting process is performed according to an embodiment of the present disclosure.

FIG. 13 is a view illustrating a state in which a width of a body forming part is modified to a shape required for the base material in a fixing process according to an embodiment of the present disclosure.

The manufacturing method of the retainer according to an embodiment of the present disclosure may include a data acquisition process in which scanning data of a tooth arrangement are acquired, a data processing process in which the scanning data are processed, a data conversion process in which corrected data are converted into laser processing data, a laser cutting process in which a base material is laser cut, an additional processing process in which a body forming part that is laser cut is additionally processed, and a body separation process in which the body forming part that is additionally processed is separated from the base material, and a width modification process in which a width of the separated body forming part is modified.

First, three-dimensional scanning data of a tooth arrangement may be acquired by using a three-dimensional scanning apparatus.

At this time, scanning data refer to photographed data of the tooth arrangement of the upper jaw or the lower jaw where the body 100 will be attached, the photographed data being photographed by using a 3D camera.

The scanning data may include the tooth arrangement, a shape of an interdental shape formed on the tooth arrangement, a tooth surface curve of each tooth, a tooth surface inclination of each tooth, and so on.

The scanning data may be a file corresponding to an stl formatted file. [S100, Data Acquisition Process]

After the data acquisition process, the data processing process for generating a processing line defining a laser cutting shape for manufacturing the body 100 on the basis of the scanning data may be performed. The data processing process may include a processing line generation process and a processing line correction process. [S200, Data Processing Process]

After the scanning data are acquired, a position of a virtual body may be set on the scanning data, and a position of a reference surface on which the virtual body is positioned may be set on the corresponding scanning data.

The reference surface may be set so as to cross a plurality of teeth constituting the tooth arrangement, and may be set horizontally.

Then, a tangent line on which the tooth arrangement and the reference surface are in contact with each other may be extracted, and on the basis of this, a processing line for defining a laser cutting shape on the reference surface may be generated. The processing line may include a first processing line L1 in contact with tooth surfaces of the tooth arrangement, and may include a second processing line L2 spaced apart from the first processing line L1.

The first processing line L1 may extend along the tooth surface and the interdental space of each tooth, and may be formed by reflecting the shapes of the interdental space and the tooth surface of the tooth arrangement.

In addition, after the first processing line L1 is generated, when a required thickness is set as illustrated in FIG. 10, the second processing line L2 spaced apart from the first processing line L1 may be generated in response to the set thickness.

The second processing line L2 may be formed in a shape corresponding to the shape of the first processing line L1. In addition, the second processing line L2 may be spaced apart from the first processing line L1 on the reference surface, and may be spaced apart rearward for forming a front-to-rear thickness of the body 100.

An approximate thickness of the body 100 may be set by a separation distance between the first processing line L1 and the second processing line L2.

Opposite ends of the first processing line L1 and the second processing line L2 are not connected to each other, but may be formed by being spaced apart by a predetermined distance from each other. [S210, Processing Line Generation process]

Meanwhile, referring to FIG. 11, in each of the first processing line L1 and the second processing line L2, a portion corresponding to the curved protrusion part 120 may be formed by being processed such that a protruding end portion is rounded. That is, a curved end portion of each of the first processing line L1 and the second processing line L2 may be processed such that the curved end portion is not sharp.

In addition, the first processing line L1 and the second processing line L2 may be processed such that a portion of each of the first processing line L1 and the second processing line L2 corresponding to the curved protrusion part 120 is spaced further apart from the portion of each of the first processing line L1 and the second processing line L2 corresponding to the support part 110. Therefore, the front-to-rear thickness T1 of the curved protrusion part 120 may be formed to be thicker than the front-to-rear thickness T2 of the support part 110.

At this time, the first processing line L1 and the second processing line L2 may be formed to be spaced further apart from each other than the front-to-rear-thickness of the body 100 to be manufactured. Therefore, even when thickness loss of the base material occurs due to laser cutting and additional processing, the body 100 may be manufactured according to required specifications. [S220, Processing Line Correction Process]

When processing line correction process is completed, processing line data including data of the first processing line and the second processing line may be converted into laser processing data.

For example, the processing line data may be stored as two-dimensional data.

In addition, by using a program automatically generating a movement path of a laser cutting device on the basis of the two-dimensional data, the processing line data may be converted into the laser processing data.

The generated laser processing data may be a two-dimensional CAD file reflecting the processing line data. [S300, Data Conversion Process]

When the data conversion process is finished, the laser processing data may be input into the laser cutting device for laser processing.

In addition, the laser cutting device is operated according to laser processing data, and an input base material 2 may be laser cut. That is, the laser cutting device may be regarded to perform the laser cutting of the base material 2 on the basis of the processing data.

Specifically, the base material 2 may be provided in a flat plate shape formed of a shape memory alloy material. That is, the base material 2 may be a plate material formed of the shape memory alloy material. For example, the base material 2 may be a thin plate of Nitinol.

The laser cutting device may be provided with a jig in which the base material 2 is seated and fixed. In addition, the base material 2 may be seated on and fixed to the jig.

A setting value may be input to the laser cutting device before performing laser cutting. For example, an operator may set a setting values such as a processing speed of 200 mm/s, a processing acceleration of 3000 mm/s, a pulse-type pulse power of 300 w, a pulse frequency of 600 hz, a pulse time of 400 us, an argon gas pressure of 3.0 mpa, and so on.

After the base material 2 is input and the setting value of the laser cutting device is set, the operator may operate the laser cutting device.

When the laser cutting device is operated, cutting of the base material 2 is performed along the processing lines by the laser cutting device, and a body forming part 100′ having a basic shape of the body 100 may be cut and formed in the base material 2.

Meanwhile, as the opposite ends of the first processing line and the opposite ends of the second processing line are formed by being spaced apart from each other, opposite ends of the body forming part 100′ may be integrally connected to the base material 2 without being separated from the base material 2.

Specifically, as illustrated in FIG. 11, the opposite ends of the body forming part 100′ are formed to be connected integrally to the base material 2, and other parts except for the opposite ends may be formed to be physically separated from the base material 2 by laser cutting.

Referring to FIG. 11, a connection part 105′ connected integrally to the base material 2 may be formed on each of the opposite ends of the body forming part 100′.

As the connection part 105′ is formed, the body forming part 100′ is not deformed by heat generated during laser cutting. In addition, the body forming part 100′ is capable of being effectively prevented from being distorted due to temperature change during cooling of the base material 2 after the laser cutting.

That is, after the laser cutting and the cooling are completed, the body forming part 100′ is capable of being detached from the base material 2, and is capable of being stably manufactured in a required shape.

In addition, as the connection part 105′ is formed, additional processing of the body forming part 100′ having a thin and small size may be easily performed. [S400, Laser Cutting Process]

After the laser cutting process is performed, the additional processing process of additionally processing the base material 2 in which the body forming part 100′ is formed may be performed.

In the additional processing process, mechanical processing or chemical processing may be performed so that the body forming part 100′ has a final shape of the body part 100.

For example, the additional processing process may include a shape processing process in which the front and rear surfaces of the body forming part 100′ reflect tooth surface shapes. In addition, the additional processing process may include a polishing process in which the body forming part 100′ is polished at which the shape processing process is completed.

The work order of the shape processing process and the polishing process is not limited to an order in which the processes are listed, and may be changed variously according to work efficiency. For example, the polishing process may be performed after the shape processing process. Alternatively, the polishing process may be performed after a thermal treatment process is performed after the shape processing process.

Hereinafter, an example in which the polishing process is performed after the shape processing process will be described in detail. [S500, additional processing process]

The base material 2 in which the body forming part 100′ is formed may be input into the shape processing process.

The shape processing may be performed by various tools, devices, and so on capable of cutting a surface of the body forming part 100′. For example, the shape processing may be performed by a bur 3 having a cone shape.

Due to characteristics of laser processing, it may be difficult to form a vertical curve or inclination on a cut surface. Therefore, by using a cutting tool or a cutting device, vertical curves or inclinations considering a tooth surface shape of each tooth and an interdental space shape of each tooth may be processed on the front surface and the rear surface of the body forming part 100′.

Specifically, in a state in which the opposite ends of the body forming part 100′ are connected to the base material 2, the front surface of the body forming part 100′ forming the front surface of the body 100 may be processed by using the bur 3.

At this time, on the basis of the scanning data, the front surface of the body forming part 100′ may be processed according to the tooth surface shape of each tooth and the interdental space shape of each tooth.

As an example, in the front surface of the body forming part 100′, a portion corresponding to the curved protrusion part 120 may be processed such that a width of the portion is gradually narrowed or widened from downward to upward in consideration of the corresponding interdental space shape.

In addition, in the front surface of the body forming part 100′, a portion corresponding to a tooth in which a tooth surface thereof is upwardly inclined to the front side may be processed in a shape that is upwardly inclined to the front side.

In addition, in the front surface of the body forming part 100′, a portion corresponding to a tooth in which a tooth surface thereof is downwardly inclined to the front side may be processed in a shape that is downwardly inclined to the front side.

In addition, in the front surface of the body forming part 100′, a portion corresponding to a tooth in which a tooth surface thereof is curved may be processed in a curved shape.

Meanwhile, the rear surface of the body forming part 100′ that forms the rear surface of the body 100 may be processed in a shape in which the body forming part 100′ corresponds to a processed shape of the front surface of the body forming part 100′.

At this time, the rear surface processing of the body forming part 100′ may be performed after the base material 2 is turned upside down.

As the rear surface of the body forming part 100′ is processed into a shape corresponding to the processed shape of the front surface, the body 100 may be formed such that the front-to-rear thickness of the body 100 has a vertically even thickness. Therefore, the body 100 may provide a stable and uniform teeth support force.

Meanwhile, a portion in the base material 2 cut by laser during the laser cutting may be removed, and a cutting space may be formed. That is, the cutting space may be formed at a portion corresponding to the processing line in the base material 2, and may be formed at the front side and at the rear side of the body forming part 100′.

The cutting space may be divided into a first cutting space D1 formed at the front side of the body forming part 100′ and a second cutting space D2 formed at the rear side of the body forming part 100′.

The shape processing by using the burr 3 may be performed through the cutting space. [S510, Shape Processing Process]

After the shape processing process is performed, the polishing process of polishing the body forming part 100′ may be performed.

In the polishing process, the polishing process of the body forming part 100′ may be performed by using various polishing tools and various polishing apparatuses capable of polishing the surface of the body forming part 100′.

A method of polishing a plate material of a shape memory alloy material is variously disclosed in a known technology, the detailed description thereof will be omitted.

By the polishing process, the body 100 may be formed such that the body 100 has a smoother surface, and a generally safe structure may be formed since a sharp portion is removed.

Specifically, flashes caused by melting of the base material may be formed on the body forming part 100 during the laser cutting. In addition, when the shape processing process is performed, iron barbs may be formed on a processing portion.

Flashes, iron barbs, and corner portions are processed by the polishing process, so that the body forming part 100′ may be formed such that the surface of the body forming part 100′ has the smoother surface and the sharp portion is removed. [S520, Polishing Process]

After the additional processing process is completed, the body forming part 100′ may be separated from the base material 2.

The separation of the body forming part 100′ may be realized by using cutting tools such as a knife, a scissor, and so on or by breaking the connection part 105′ by holding the body forming part 100′ and then applying a predetermined force to the body forming part 100′. [S600, Body Separation process]

After the body forming part 100′ is separated, additional processing may be further performed on the body forming part 100′.

For example, a width modification process for modifying a width of the body forming part 100′ may be performed.

The width modification process may include a fixing process in which a width (a distance from a first side distal end to a second side distal end) between distal ends of the body forming part 100′ is modified to an intended width between the distal ends and then fixed, and may include a thermal treatment process in which the body forming part 100′ having the width between the distal ends thereof fixed is thermally treated so that a shape of the body forming part 100′ is maintained while the body forming part 100′ is in a state in which the width between the distal ends is modified.

The width modification process may include the fixing process and the thermal treatment process.

In addition, after the body forming part 100′ is separated, an additional processing in which the opposite ends of the body forming body 100′ are processed in smooth shapes through polishing processing and so on may be further performed. [S700, Width Modification Process]

The width modification process may be applied for the purpose of correcting a shape error of the body formed by the formation of the cutting space.

Specifically, as the portion cut by laser is removed from the base material 2 during the laser cutting, an error may occur in the shape of the manufactured body and the shape of the required body defined by the processing line data.

That is, as the cutting space is formed, an error may occur in the shape of the required body defined by the body forming part 100′ and by the processing line data generated in the data processing process.

When such a manufacturing shape error occurs in the body, it may be difficult for the retainer 1 to be in stable contact with the tooth arrangement, and there may be a problem that a foreign body sensation may increase and a failure rate may increase.

Specifically, when a shape error of the body caused by the cutting space occurs, the body in which the error occurs may have a size smaller than the size of the required body. Therefore, since the body in which the error occurs is not in contact with some of the teeth and is splayed, the body is difficult to be attached to the tooth arrangement and the foreign body sensation increases.

In order to prevent such a problem, correction of the shape error of the body is required.

As in the embodiment described above, when the body 100 is applied so that the front surface of the body 100 is in close contact with the tooth arrangement from the rear side of the tooth arrangement, the shape error may be corrected by slightly expanding the front surface of the body forming part 100′.

Referring to FIG. 13, in the fixing process, the body forming part 100′ may be fixed to the base material 2 again.

Specifically, a cutting space formed by laser cutting and a space part 2a formed by a separation of the body forming part 100′ may be formed in the base material 2.

The space part 2a may be formed such that the space part 2a including the cutting space has a size larger than an area of a cross-sectional surface of the body forming part 100′.

In a state in which the body forming part 100′ is inserted into the space part 2a, the body forming part 100′ is brought into close contact with the space part 2a so that the first cutting space D1 disappears, so that the shape of the body forming part 100′ is capable of being corrected close to the shape of the required body.

Of course, in a case in which the body 100 is applied such that the rear surface of the body 100 is in close contact with the tooth arrangement from the front side of the tooth arrangement, the body forming part 100′ is brought in to close contact with the rear side of the space part 2a so that the second cutting space D2 disappears, so that the shape of the body forming part 100′ is capable of being corrected close to the shape of the required body.

That is, according to a tooth arrangement contact position of the retainer 1, in a state in which the body forming part 100′ is inserted into the space part 2a, the body forming part 100′ is brought into close contact with the front side or the rear side of the space part 2a so that any one of the first cutting space D1 and the second cutting space D2 disappears, so that the shape of the body forming part 100′ is capable of being corrected close to the shape of the required body.

A close contact means 6 for closely fixing the body forming part 100′ may be provided.

The close contact means 6 may be inserted into the cutting space, and may be applied in various forms in which the body forming part 100′ is capable of being in close contact with the cutting space to the front side or the rear side.

For example, the close contact means 6 may be applied as a pin having a column shape or a wedge shape capable of being inserted into the cutting space.

The close contact means 6 may be formed such that the contact means 6 has a thickness corresponding to the sum of a front-to-rear width of the first cutting space D1 and a front-to-rear width of the second cutting space D2.

Therefore, when the close means 6 is inserted into a side of the second cutting space D2, the body forming part 100′ is moved to a side of the first cutting space D1, so that the body forming part 100′ is capable of being in close contact with the front surface of the space part 2a.

The close contact means 6 may be provided with a plurality of close contact means 6 such that the body forming part 100′ is stably brought into close contact with the close contact means 6, and the plurality of close contact means 6 may be inserted into the cutting space and may be positioned at positions spaced apart from each other.

In addition, the body forming part 100′ in which the width thereof is modified may be more stably fixed to the base material 2 by using a fixing means 7 while the body forming part 100′ is in a state in which the width between the distal ends thereof is modified.

The fixing means 7 may be a member configured to press the base material 2 and the body forming part 100′ together from the front and rear sides.

For example, the fixing means 7 may be applied as a clip which has elasticity and to which the base material 2 and the body forming part 100′ are capable of being inserted thereinto, or the fixing means 7 may be applied as tongs having elasticity.

At this time, the close contact means 6 and the fixing means 7 may be formed of a material that is not deformed or broken in the thermal treatment process to be described later, and may be formed of a stainless material for example. [S710, Fixing Process]

In a state in which the body forming part 100′ is fixed to the base material 2 and the width between the distal ends is modified, a combination of the body forming part 100′ and the base material 2 may be input into a thermal treatment apparatus 5 and may be thermally treated.

At this time, the thermal treatment process may be performed such that the body forming part 100′ is in a state in which the shape of the body forming part 100′ having the modified width between the distal ends is maintained.

A method of thermally treating a plate material of a shape memory alloy to deform a shape is variously disclosed in a conventional technology, so that more detailed description thereof will be omitted.

Due to the thermal treatment fixing, even when the body forming part 100′ is separated from the base material 2, the body forming part 100′ may be maintained in a state in which the width between the distal ends thereof is modified.

That is, by the thermal treatment process, the width between the distal ends of the body forming part 100′ is corrected, so that the body 100 having a shape corresponding to the shape of the required body is capable of being manufactured. [720, Thermal Treatment Process]

Meanwhile, in the embodiment of the method for manufacturing the retainer described above, an example in which the connection part 105′ is formed on the base material 2 during the laser cutting process is described, but the present disclosure is not limited thereto, and some processes may be omitted or modified and applied according to the convenience of manufacturing or the required shape of the body.

For example, in the laser cutting process, it may be possible to apply such that the body forming part is completely cut from the base material.

Specifically, in the data processing process, the processing line data may be generated such that the opposite ends of the first processing line and the opposite ends of the second processing line are connected to each other.

In addition, in the laser cutting process, the connection part 105′ may not be formed, and the body forming part may be completely cut off and separated from the base material.

In addition, in the additional processing process, the shape processing process may be performed by holding the body forming part completely separated from the base material or by fixing the body forming part by using a tool such as tongs. In addition, the polishing process may be performed by inputting the body completely separated from the base material to the polishing tool, the polishing apparatus, and so on.

Meanwhile, the width modification process may be applied for orthodontic treatment that expands or reduces the tooth arrangement, and may be applied for a shape modification corresponding to a final orthodontic state of the tooth arrangement.

Hereinafter, other embodiments of the width modification process will be described in detail with reference to the drawings.

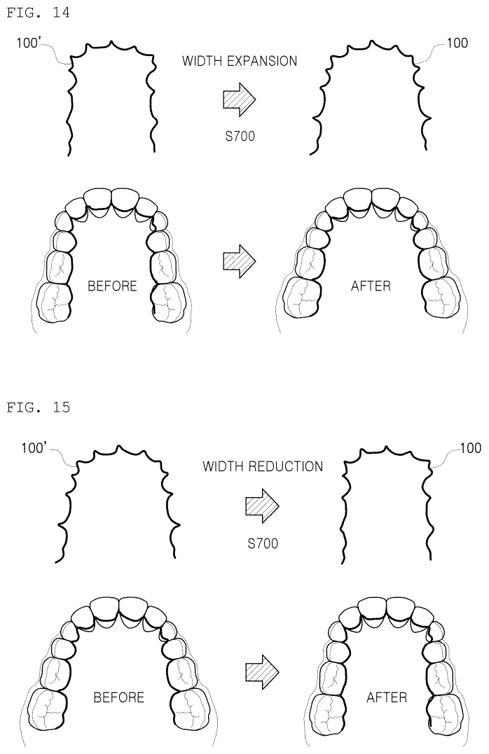

FIG. 14 is a view illustrating the retainer having an expanded width manufactured for expanding and correcting the tooth arrangement according to another embodiment of the present disclosure.

FIG. 15 is a view illustrating the retainer having a reduced width manufactured for reducing and correcting the tooth arrangement according to still another embodiment of the present disclosure.

Referring to FIG. 14, when the retainer 1 is intended to be applied to orthodontic treatment for expanding a patient's tooth arrangement, the body 100 is required to be manufactured with a width between the distal ends required for expansion orthodontic treatment.

That is, the body 100 is required to be manufactured such that the body 100 has a shape corresponding to a shape of a tooth arrangement in a state in which the expansion orthodontic treatment is completed.

In this case, the body 100 may be fixed to the tooth arrangement by being elastically deformed and being in close contact with the body 100 so as to correspond to an initial tooth arrangement. In addition, the tooth arrangement is pressed by characteristics of the shape memory alloy so that the tooth arrangement is expanded, so that the tooth arrangement is corrected to be expanded to the required shape.

To this end, in the fixing process, the body forming part 100′ separated from the base material 2 may be fixed in a form of a shape having a width between distal ends expanded required for a shape of a separate jig or a shape corresponding to the required tooth arrangement.

In addition, the body forming part 100′ may be input into the thermal treatment process and thermally treated while the body forming part 100′ is in a state in which the width between the distal ends thereof expanded is fixed, and then the body forming part 100′ may be thermally treated.

As the thermal treatment process is completed, the body forming part 100′ may be manufactured into the body 100 having the width between the distal ends thereof required for the expansion orthodontic treatment.

Hereinafter, still another embodiment of the width modification process will be described in detail with reference to the drawings.

Referring to FIG. 15, when the retainer 1 is intended to be applied to orthodontic treatment for reducing a patient's tooth arrangement, the body 100 is required to be manufactured with a width between the distal ends thereof required for reduction orthodontic treatment.

That is, the body 100 is required to be manufactured such that the body 100 has a shape corresponding to a shape of a tooth arrangement in a state in which the reduction orthodontic treatment is completed.

In this case, the body 100 may be fixed to the tooth arrangement by being elastically deformed and being in close contact with the body 100 so as to correspond to an initial tooth arrangement. In addition, the tooth arrangement is pressed by characteristics of the shape memory alloy so that the tooth arrangement is reduced, so that the tooth arrangement is corrected to be reduced to the required shape.

To this end, in the fixing process, the body forming part 100′ separated from the base material 2 may be fixed in a form of a shape having a width between distal ends reduced required for a shape of a separate jig or a shape corresponding to the required tooth arrangement.

In addition, the body forming part 100′ may be input into the thermal treatment process and thermally treated while the body forming part 100′ is in a state in which the width between the distal ends thereof reduced is fixed, and then the body forming part 100′ may be thermally treated.

As the thermal treatment process is completed, the body forming part 100′ may be manufactured into the body 100 having the width between the distal ends thereof required for the reduction orthodontic treatment.

Meanwhile, in the embodiments of the method for manufacturing the retainer described above, an example in which the body forming part 100′ is formed by laser cutting and then the body forming part 100′ is manufactured in a width-modified shape corresponding to the shape of the required body is described. However, the present disclosure is not limited thereto, and various manufacturing methods capable of manufacturing the body corresponding to the shape of the required body may be applied.

For example, the width modification process may be omitted, and in consideration of the cutting space formed by laser in the data processing process, a method in which the processing line is corrected so that the shape of the body forming part 100′ cut in the laser cutting process corresponds to the shape of the required body may be applied.

In addition, the width modification process may be omitted, and a method in which a final correction shape of the tooth arrangement for expansion or reduction orthodontic treatment of the tooth arrangement is derived in the data processing process and then processing line data of a shape corresponding to the final correction shape of the tooth arrangement are generated may be applied.

According to the retainer 1 according to an embodiment of the present disclosure described above, the body 100 that is in close contact with the tooth arrangement is formed by reflecting the teeth surface shape and the interdental space shape of the tooth arrangement.

Therefore, since the body 100 is in close and stable contact with each tooth, a problem in which foreign substances are caught between the body 100 and the teeth may be prevented, and the body 100 may be in more stable and close contact with the teeth.

In addition, as the support part 110 is formed with a uniform front-to-rear thickness and with a vertical height, each tooth forming the tooth arrangement is capable of being uniformly and stably supported. Therefore, an effect of correcting the tooth arrangement may be maximized.

In addition, since the curved protrusion part 120 having the curved shape is formed such that the curved protrusion part 120 has the front-to-rear thickness thicker than the front-to-rear thickness of the support part 110, occurrence of fracture of the curved protrusion part may be effectively prevented.

In addition, as the protruding end portion of the curved protrusion part 120 is formed to be rounded, breakage of the protruding end portion may be effectively prevented, and the body 100 may have more excellent durability.

In addition, since the curved protrusion part 120 is formed such that the curved protrusion part 120 has a width that is gradually narrowed or widened upward so as to correspond to the corresponding interdental space shape, the curved protrusion part 120 is capable of being stably inserted between the teeth without interference, and the curved protrusion part 120 is capable of being in close contact with the inner side surfaces of the teeth forming the interdental space.

In addition, since the shape error of the body generated by the laser cutting is removed, the body 100 is more stably in close contact with the tooth arrangement, so that the tooth arrangement correction effect may be maximized, and the occurrence of foreign body sensation due to the shape error may be prevented.

Meanwhile, according to the method for manufacturing the retainer according to an embodiment of the present disclosure described above, the body 100 may be formed as a single integrated configuration, so that the manufacturing cost of the retainer 1 may be reduced.

In addition, as the body 100 is manufactured by being laser cut on the basis of the 3D scanning data of the tooth arrangement, the time required for manufacturing the retainer may be significantly reduced.

In addition, as the time required for manufacturing the retainer is reduced, the deformation of the tooth arrangement during the manufacturing time of the retainer is minimized. Therefore, an attachment time may be reduced since the manufactured retainer and the teeth are stably matched. Therefore, the patient's satisfaction with treatment may be significantly increased.

In addition, when the body forming part 100′ is formed by laser cutting the base material 2, the body forming part 100′ is formed while the opposite ends of the body forming part 100′ are connected to the base material 2. Therefore, during the laser cutting process, the body forming part 100′ may be prevented from being deformed by external force or heat in the additional processing process, and a defect in shape of the body 100 may be prevented.

In addition, due to characteristics of laser processing, the vertical curve or the vertical inclination may be difficult to be formed on the cutting surfaces. However, in the method for manufacturing the retainer according to an embodiment of the present disclosure, a processing line defining a laser cutting shape on the basis of the 3D scanning data of the tooth arrangement are generated, and then the body forming part 100′ is formed by performing laser cutting along the processing line. Then, by performing a separate additional processing, the front and rear surfaces of the body forming part 100′ are processed in consideration of the tooth surface shape of each tooth and the interdental space shape of each tooth. Therefore, the body 100 in which the vertical curve and the vertical inclination considering the tooth surface shape of each tooth and the interdental space shape of each tooth are formed in the front and rear surfaces of the body 100 is capable of being manufactured.

In addition, the body 100 in which a shape error of the body generated by the laser cutting is removed is capable of being manufactured. In addition, since the manufactured body 100 is more stably in close contact with the tooth arrangement, the tooth arrangement correction effect may be maximized, and the occurrence of foreign body sensation due to the shape error may be prevented.

### INDUSTRIAL APPLICABILITY

According to an embodiment of the present disclosure, a retainer is manufactured by laser cutting a base material on the basis of 3D scanning data of a tooth arrangement, the base material having a shape memory alloy. Furthermore, after the laser cutting, a shape error generated due to loss of a material of a cutting region is corrected through an additional width modification process.

Accordingly, as the shape error caused by the laser cutting is corrected, the retainer and each tooth are in completely close contact with each other, so that a tooth arrangement maintaining effect may be maximized. Furthermore, by applying the laser cutting based on the 3D scanning data, the manufacturing time may be significantly reduced, so that the present disclosure is industrially applicable.

1. A retainer comprising:
a body formed of a shape memory alloy material and formed as a single integrated configuration, the body having a first surface in close contact with each tooth along a tooth arrangement,
wherein the body comprises:
a curved protrusion part that protrudes toward an interdental space so that the curved protrusion part is inserted into the interdental space, the curved protrusion part being in close contact with inner tooth surfaces of a plurality of teeth forming the interdental space; and
a plurality of support parts in close contact with tooth surfaces of each tooth outside the interdental space, and
the body is manufactured by being laser cut from a base material of the shape memory alloy material on the basis of 3D scanning data of the tooth arrangement and then a width between distal ends thereof being modified so as to correct at least a shape error caused by the laser cutting.

2. The retainer of claim 1, wherein, in order to correct the shape error, the body is laser cut from the base material, then expands and is fixed such that the width between the distal ends thereof is widened or is reduced and fixed such that the width between the distal ends thereof is narrowed, and then is thermally treated, thereby manufacturing the body in which a shape of the modified width between the distal ends is maintained.

3. A method for manufacturing a retainer provided with a body which comprises a curved protrusion part that protrudes so as to be inserted into an interdental space so that the body is in close contact with tooth surfaces of a plurality of teeth forming a tooth arrangement and which comprises a support part that is in close contact with tooth surfaces of each tooth outside the interdental space, the method comprising:
a three-dimensional scanning data acquisition process in which three-dimensional scanning data of the tooth arrangement are acquired by using a three-dimensional scanning apparatus;
a data processing process in which processing line data defining a laser cutting shape for manufacturing the body are generated on the basis of the scanning data of the tooth arrangement;
a laser cutting process in which a body forming part configuring the body is manufactured by laser cutting a base material formed of a shape memory alloy material on the basis of the generated processing line data; and
a width modification process in which the body forming part expands and is fixed such that a width between distal ends thereof is widened or is reduced and fixed such that the width between the distal ends thereof is narrowed, and then is thermally treated, thereby manufacturing the body in which a modified width between distal ends is maintained.

4. The method of claim 3, wherein, in the laser cutting process, a portion cut from the base material is removed, and cutting spaces are formed on opposite sides with respect to the body forming part, and
the width modification process comprises:
a fixing process in which a first side surface of the body forming part and an inner facing surface of the base material facing each other through a first side cutting space are brought into close contact with each other so as to remove the first side cutting space in the cutting spaces of the opposite sides, thereby fixing the body forming part to the base material while the body forming part is in a state in which the width between the distal ends thereof is modified; and
a thermal treatment process in which the body forming part having the modified width between the distal ends and fixed to the base material is thermally treated so that a shape of the body forming part having the modified width between the distal ends is maintained.

5. The method of claim 3, further comprising an additional processing process which is performed after the laser cutting process and in which the body forming part is cut so that changes in vertical curve of tooth surfaces of each tooth and in vertical width of the interdental space are reflected to the body forming part.
